(19) United States
(12) Patent Application Publication
(10) Pub. No.: US 2016/0231474 A1
(43) Pub. Date: Aug. 11, 2016

(54) LIGHT CONDENSING OPTICAL SHEET AND METHOD FOR MANUFACTURING SAME

(71) Applicant: KOLON INDUSTRIES, INC., Gyeonggi-do (KR)

(72) Inventors: Su Ji KIM, Yongin-si (KR); Kyung Hwa KIM, Yongin-si (KR); Chang Won PARK, Yongin-si (KR); Tae Kyung KIM, Yongin-si (KR)

(73) Assignee: KOLON INDUSTRIES, INC., Gwacheon-si, Gyeonggi-do (KR)

(21) Appl. No.: 15/025,587

(22) PCT Filed: Sep. 30, 2014
(86) PCT No.: PCT/KR2014/009185

§ 371 Date: Mar. 29, 2016

(30) Foreign Application Priority Data
Sep. 30, 2013 (KR) 10-2013-0116612
Sep. 29, 2014 (KR) 10-2014-0130135

(51) Int. Cl. G02B 5/04; G02B 3/00; G02F 1/1335

(52) U.S. Cl. CPC G02B 5/045; G02F 1/1336; G02B 3/0056; C03C 17/00

(57) ABSTRACT

Disclosed are a light-condensing optical sheet and a method of manufacturing the same, wherein during the manufacture of a light-condensing optical sheet, the amount of light is adjusted in a curing process, and the amount of a photoinitiator is optimized, whereby the light-condensing optical sheet is configured to minimize damage upon external impact.

### TECHNICAL FIELD

The present invention relates to a light-condensing optical sheet for use in a liquid crystal display (LCD) and a method of manufacturing the same.

### BACKGROUND ART

Useful as an optical display device, LCDs are of an indirect light emission type, which displays an image by adjusting the transmittance of an external light source, and thus a backlight unit, serving as a light source element, is considered important in determining the characteristics of LCDs.

In particular, as LCD panel fabrication techniques are advanced, the demand for slim LCDs having high luminance is increasing, and thus many attempts have been made to increase the luminance of the backlight unit. LCDs suitable for use in monitors, PDAs (Personal Digital Assistants), laptop computers, etc. are evaluated to be excellent when bright light is emitted using a low energy source. Hence, forward luminance is deemed to be very important in LCDs.

The LCD is configured such that light passing through a light diffusion layer is diffused in all directions, and the quantity of traveling in the forward direction is much too low. Accordingly, many attempts have been made to exhibit higher luminance with lower power consumption. Moreover, as the area of the display is enlarged, the viewing angle is required to be wider so that the image can be viewed by more users.

When the power of the backlight unit is increased, power consumption is raised and power loss attributable to heat is also increased. In the case of portable displays, the capacity of the battery is increased and the lifetime of the battery is shortened.

In order to increase luminance, methods of imparting light with directionality have been suggested. To this end, a variety of lens sheets have been developed. An example of such a sheet is an optical sheet having a prism array on the surface thereof.

Typically, an optical sheet having a prism array may have a triangular array structure, inclined at 45° to increase forward luminance.

Since the optically structured surface of the optical sheet is mountain-shaped, the top of the mountain shape may be easily broken or distorted by small external scratches, thus damaging the prism structures. Also, all the angles of light emitted from the prism structures having the same shape in the array are identical to each other. In the case where a mountain shape in the prism array is slightly damaged or a small scratch is created on the inclined portion thereof, the light emission paths come to differ between the damaged portion and the normal portion, undesirably reducing luminance and causing defects. Thus, in the production of a prism sheet, problems in which the front surface of the prism sheet cannot be used due to the presence of small defects may arise, undesirably leading to a decrease in productivity and thus to a high cost burden. In the real world, manufacturers that assemble backlight modules suffer greatly from defects attributable to damage to prism structures by scratching caused when the prism sheets are handled.

Also, sheets and films are layered on the backlight unit, and a plurality of prism films may be provided to increase luminance. When the upper surface of the lower prism film comes into contact with the lower surface of the upper prism film, the prism structures are undesirably damaged.

In order to prevent damage to the prism structures, a protection film is conventionally provided. However, as the LCD panel is required to become slim, the trend is to omit such a film or to use a multifunctional sheet, and furthermore, when the additional formation of the protection film is performed, production costs are increased and temporal and physical efficiencies are decreased.

In addition to damage to the prism structures due to handling in the manufacturing process, portable displays are frequently transported in the state of being placed in bags, with an increase in the use of portable displays such as laptop computers or PDAs. During the transport thereof, in the case where an impact is applied to the display when a user runs or a car stops suddenly, the prism structures in the display are damaged even in the presence of the protection film, negatively affecting the screen image quality.

Meanwhile, the demand for high-quality and highly reliable products is recently increasing in the display market. Furthermore, elasticity of the sheet for use in the display is important because the sheet is sensitive to touch due to an increase in the use of touch screens, and also because portability is required more than in the case of conventional display devices.

Thus, there is an urgent need to develop a light-condensing optical sheet, which includes an optically structured surface that may flexibly cope with external forces, and is not damaged when dropped or subjected to physical impact.

### DISCLOSURE

### Technical Problem

Therefore, the present invention is intended to provide a light-condensing optical sheet, which is not damaged by external impact and has high resilience.

In addition, the present invention is intended to provide a method of manufacturing a light-condensing optical sheet, which is not damaged by external impact and has high resilience.

### Technical Solution

A preferred first embodiment of the present invention provides a method of manufacturing a light-condensing optical sheet, comprising: (S1) applying a curing composition for forming a structural layer, comprising 100 parts by weight of a curable resin and 1 to 4 parts by weight of a photoinitiator, on one surface of a substrate layer; (S2) locating the substrate layer, coated with the composition for forming a structural layer in S1, on a frame of a shaping roller having a three-dimensional structure; and (S3) radiating light in an amount of 200 to 2000 mJ/cm² onto the substrate layer located on the frame of the shaping roller having the three-dimensional structure so as to cure the composition, thus forming a three-dimensional structure.

In this embodiment, the curing composition for forming a structural layer may comprise a curable resin selected from the group consisting of urethane acrylate, a trifunctional acrylate compound, a UV curable monomer, and silicon acrylate; and a photoinitiator.

In this embodiment, the three-dimensional structure may be selected from the group consisting of a prism structure, a micro-lens structure, and a lenticular structure.

In this embodiment, the photoinitiator may be selected from the group consisting of a phosphine oxide-, a propanone-, a ketone-, and a formate-based photoinitiator.

A preferred second embodiment of the present invention provides a light-condensing optical sheet including a structural layer having a plurality of three-dimensional structures, wherein a luminance uniformity of the light-condensing optical sheet is measured to be 1.40 or less after dropping of a steel ball onto the light-condensing optical sheet from a height of 7 cm or more in the following ball drop testing:

<Ball Drop Testing>

A light-condensing optical sheet is mounted to a backlight unit (BLU), and a steel ball having a weight of 68 g and a diameter (R) of 2 cm is dropped once onto the BLU in a perpendicular direction from a predetermined height, wherein the predetermined height indicates an interval between the ball and an upper surface of the light-condensing optical sheet in a direction perpendicular to the mounted light-condensing optical sheet.

In this embodiment, the luminance uniformity of the light-condensing optical sheet may be measured to be 1.40 or less after dropping of the steel ball onto the light-condensing optical sheet from a height of 70 cm or more in the ball drop testing.

In this embodiment, the structural layer having the plurality of three-dimensional structures may be formed from a curing composition for forming a structural layer.

In this embodiment, the curing composition for forming a structural layer may comprise a curable resin selected from the group consisting of urethane acrylate, a trifunctional acrylate compound, a UV curable monomer, and silicon acrylate; and a photoinitiator.

In this embodiment, the photoinitiator may be contained in an amount of 1 to 4 parts by weight based on 100 parts by weight of the curable resin.

In this embodiment, the photoinitiator may be selected from the group consisting of a phosphine oxide-, a propanone-, a ketone-, and a formate-based photoinitiator.

### Advantageous Effects

According to the present invention, a light-condensing optical sheet and a method of manufacturing the same can be provided, wherein the light-condensing optical sheet can exhibit high resilience even when subjected to external impact, while minimizing the occurrence of damage due to such external impact.

### DESCRIPTION OF DRAWINGS

FIG. 1 illustrates a ball drop tester according to the present invention;

FIG. 2 schematically illustrates ball drop testing according to the present invention;

FIG. 3 is a photograph illustrating the surface of the light-condensing optical sheet of Example 2;

FIG. 4 is a photograph illustrating the surface of the light-condensing optical sheet of Comparative Example 5;

FIG. 5 is a scanning electron microscope (SEM) image illustrating the surface of the light-condensing optical sheet of Example 2; and

FIG. 7 is an SEM image illustrating the surface of the light-condensing optical sheet of Comparative Example 5.

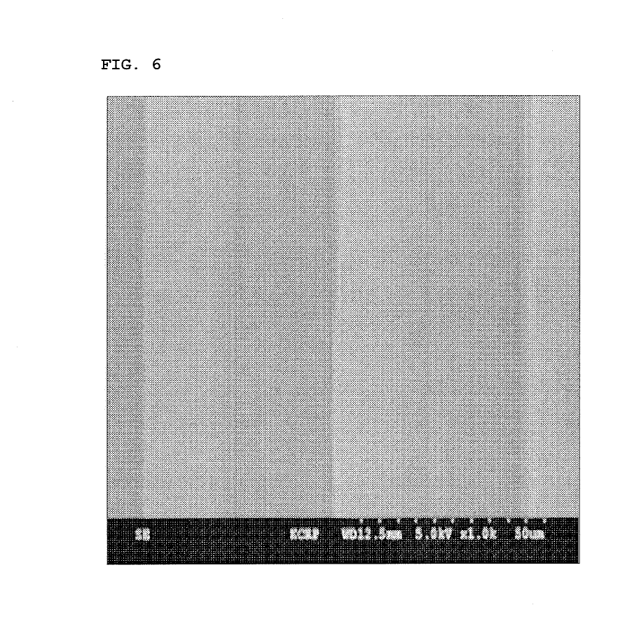

### BEST MODE

Hereinafter, a detailed description will be given of the present invention.

The present invention addresses a method of manufacturing a light-condensing optical sheet, comprising: (S1) applying a curing composition for forming a structural layer, comprising 100 parts by weight of a curable resin and 1 to 4 parts by weight of a photoinitiator, on one surface of a substrate layer; (S2) locating the substrate layer, coated with the composition for forming a structural layer in S1, on a frame of a shaping roller having a three-dimensional structure; and (S3) radiating light in an amount of 200 to 2000 mJ/cm² onto the substrate layer located on the frame of the shaping roller having the three-dimensional structure so as to cure the composition, thus forming a three-dimensional structure.

[(S1)]

(S1) is a step of applying the curing composition for forming a structural layer, comprising 100 parts by weight of a curable resin and 1 to 4 parts by weight of a photoinitiator, on one surface of the substrate layer.

The substrate layer may be formed of a material selected from the group consisting of polyethylene terephthalate, polyethylene naphthalate, polycarbonate, polystyrene, polymethacrylate, polymethylmethacrylate, polyacrylate, polyimide, polyamide, and mixtures thereof.

The curing composition for forming a structural layer is composed of a curable resin selected from the group consisting of urethane acrylate, a trifunctional acrylate compound, a UV curable monomer, and silicon acrylate; and a photoinitiator.

Specific examples of the curable resin may include urethane acrylate, such as urethane acrylate oligomer, a trifunctional acrylate compound, such as phenoxyethyl methacrylate, phenoxyethyl acrylate, trimethylolpropane triacrylate, glycerin propoxylated triacrylate, and pentaerythritol triacrylate, and a UV curable monomer, such as a styrene-based monomer, a butadiene-based monomer, and an isoprene-based monomer.

In order to increase the refractive index in the preparation of the urethane acrylate oligomer, a high-refractive-index monomer may be used, and examples of the high-refractive-index monomer may include 9,9-bis(4-hydroxyphenyl)fluorene, bisphenol A, bis(4-hydroxyphenyl)methane, and 4,4-thiodiphenol.

The curable resin may be used by mixing one or more curable resins. In the present invention, a mixture of three curable resins is used, whereby elastic properties are exhibited, and the viscosity of the compound is lowered to the range of about 500 to 900 cps, thus improving processability.

The above effects may be obtained when three curable resins are mixed at a weight ratio of 1 to 5:2 to 8:1 to 3.

Alternatively, the curable resin may be used by mixing two or more curable resins. In this case, the resins are preferably mixed at a ratio of 1:9 to 9:1.

The photoinitiator may be selected from the group consisting of a phosphine oxide-based photoinitiator, a propanone-based photoinitiator, a ketone-based photoinitiator, and a formate-based photoinitiator, and specific examples thereof may include a phosphine oxide-based photoinitiator, such as 2,4,6-trimethylbenzoyl diphenylphosphine oxide, phosphine oxide, phenyl bis (2,4,6-trimethylbenzoyl) and the like, a propanone-based photoinitiator, such as 2-methyl-1-[4-(methylthio)phenyl]-2-(4-morpholinyl)-1-propanone, 2-hydroxy-2-methyl-1-phenyl-1-propanone and the like, a ketone-based photoinitiator, such as 1-hydroxy-cyclohexyl-phenyl ketone, etc., and a formate-based photoinitiator, such as methylbenzoylformate, etc.

The amount of the photoinitiator may be 1 to 4 parts by weight based on 100 parts by weight of the curable resin. If the amount of the photoinitiator is less than 1 part by weight, unreacted monomers may remain in a radical state, and thus curing does not occur and problems of stickiness may arise. On the other hand, if the amount thereof exceeds 4 parts by weight, over-curing occurs, and radical propagation may be decreased, thus shortening the polymer chain. The resulting optical sheet may be easily broken under external impact and may become weakly resistant to acids. Specifically, the reactive group of the monomer participating in the initial reaction becomes excessive, thus shortening the polymer chain. The resulting optical sheet may be easily broken even under external impact and may become weakly resistant to acids.

The curing composition for forming a structural layer may further include an additive, in addition to the curable resin and the photoinitiator. For example, the additive may include a UV absorbent.

The additive may be contained in an amount of 1 to 5 parts by weight based on 100 parts by weight of the curable resin.

The applying may be performed using any coating process typically used in the art to which the present invention pertains.

[(S2)]

(S2) is a step of locating the substrate layer, coated with the composition for forming a structural layer in S1, on the frame of the shaping roller having the three-dimensional structure.

The three-dimensional structure is selected from the group consisting of a prism structure, a micro-lens structure, and a lenticular structure.

As such, the frame of the shaping roller is preferably maintained in the temperature range of 35 to 50° C., thereby maintaining the viscosity of the mixture to thus improve spreadability.

[(S3)]

(S3) is a step of radiating light in an amount of 200 to 2000 mJ/cm² onto the substrate layer located on the frame of the shaping roller having the three-dimensional structure so as to cure the composition, thus forming a three-dimensional structure.

If the amount of light is less than 200 mJ/cm², the photoinitiator does not perform its function and a radical reaction is not promoted, making it impossible to grow a polymer chain.

Specifically, the three-dimensional structure is maintained when curing is carried out through a radical reaction. To this end, the radical reaction is carried out in the sequence of 1) initiation, 2) propagation, and 3) termination. The initiation step in 1) is performed when light is first radiated. As such, the light should be radiated in the amount necessary to initiate the reaction. If the amount of light is less than 200 mJ/cm², non-initiated monomers (which do not participate in the radical reaction) are left behind, and unreacted residue may also be left behind. On the other hand, if the amount of light exceeds 2000 mJ/cm², many monomers participating in the radical reaction react instantly, and thus do not undergo the propagation step in 2), undesirably shortening the polymer chain. When such problems occur, the polymer chain is short and rigid after curing, that is, after termination of the reaction, and elastic properties cannot be obtained. Also, a free volume (which is space in which polymer chains may move) between polymers disappears, and thus elastic properties cannot be exhibited.

Specifically, a light-condensing optical sheet, especially a light-condensing optical sheet for use in a laptop computer, PDA or a mobile phone, may frequently be subjected to external impacts. Hence, it is important that the optical sheet is not damaged by such external impact and that resilience to external impact is improved. However, these problems still occur in the related art.

In the present invention, light is applied in an optimal amount, whereby the length of the optimal polymer chain and free volume may be ensured in the optical sheet so as to improve resilience to external impact while preventing damage from occurring under external impact.

In order to solve the problems of the related art, the present inventors have ascertained the necessity of a long polymer chain and a sufficient free volume, and have performed testing to determine optimal conditions with regard to the amount of photoinitiator and the amount of light. Therefore, the light-condensing optical sheet according to the present invention, especially the light-condensing optical sheet for use in a laptop computer, PDA or a mobile phone, may improve resilience while preventing damage from occurring under external impact.

In order to objectively evaluate the degree of damage under external impact and the effects of resilience, ball drop testing may be used.

The light-condensing optical sheet according to the present invention is an optical sheet that has excellent resilience under external impact, and a method of quantifying the resilience under external impact is exemplified by ball drop testing.

Ball drop testing is carried out to evaluate whether the surface of the optical sheet is damaged when a ball is dropped onto the optical sheet. In the case where ball drop testing is performed, an impact is applied to the upper surface of the optical sheet when the ball is dropped perpendicularly onto the optical sheet. In the case where ball drop testing is performed on a conventional optical sheet, a ball that is dropped perpendicularly strikes the optical sheet and then rebounds, undesirably generating a white spot or a black spot.

In the light-condensing optical sheet according to the present invention, a white spot or a black spot is not formed even when the optical sheet is repeatedly impacted by an object that is dropped perpendicularly under the condition that, in ball drop testing, a steel ball is dropped onto the light-condensing optical sheet from a height of 7 cm or more, and preferably 70 cm or more, in which case the luminance uniformity of the light-condensing optical sheet after dropping was measured to be 1.40 or less.

Ball drop testing is performed as follows.

<Ball Drop Testing>

A light-condensing optical sheet is mounted to a backlight unit (BLU), and a steel ball having a weight of 68 g and a diameter (R) of 2 cm is dropped once onto the BLU in a perpendicular direction from a predetermined height.

The predetermined height indicates the interval between the ball and the upper surface of the light-condensing optical sheet in a direction perpendicular to the mounted light-condensing optical sheet.

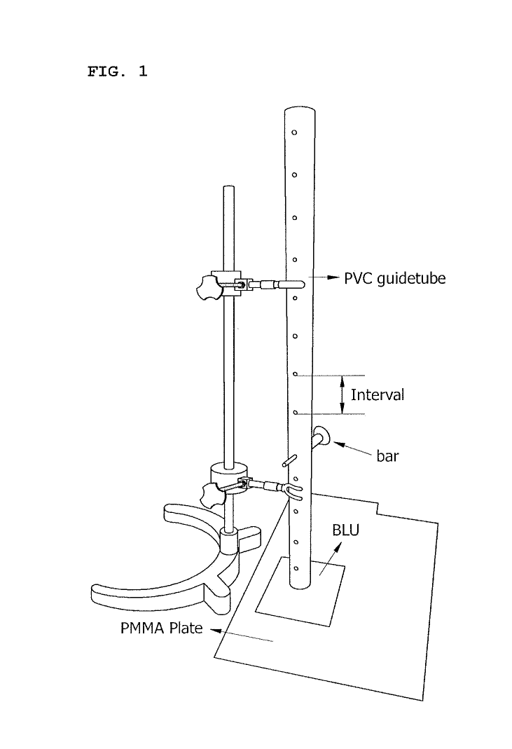

FIG. 1 illustrates the ball drop tester according to the present invention.

In ball drop testing with reference to FIG. 1, holes are formed in a PVC guide tube so as to form positions at predetermined heights, and a bar is fitted into the holes. Next, the steel ball is inserted into the PVC guide tube, after which the bar, fitted into the holes at a predetermined height, is removed, whereby the steel ball is dropped onto the BLU from a predetermined height. As such, the height is variously set by adjusting the interval.

Based on the results of ball drop testing, the dropping height of the steel ball at which the luminance uniformity of the light-condensing optical sheet is measured to be 1.40 or less after dropping of the steel ball thereon, that is, the dropping height of the steel ball that is dropped onto the light-condensing optical sheet in the ball drop testing, is 7 cm or more, and preferably 70 cm or more. The higher the dropping height of the ball, the better the ball drop testing results. This means that the light-condensing optical sheet is strongly resistant to external impact and manifests excellent resilience.

As such, if the luminance uniformity of the light-condensing optical sheet after dropping of the steel ball thereon exceeds 1.40, a defect such as a white spot or a black spot may be observed with the naked eye at the point where the steel ball is dropped onto the light-condensing optical sheet.

The light-condensing optical sheet including the structural layer having a plurality of three-dimensional structures, manufactured by the method of manufacturing the light-condensing optical sheet including (S1) to (S2) as mentioned above, was subjected to ball drop testing. As a result, the luminance uniformity of the light-condensing optical sheet after dropping of the steel ball thereon was measured to be 1.40 or less. If the luminance uniformity exceeds 1.40, a defect such as a white spot or a black spot may be created at the point where the steel ball is dropped onto the light-condensing optical sheet. This is because the elasticity of the light-condensing optical sheet is deteriorated and thus the three-dimensional structures of the structural layer are damaged by external impact. Thus, if the dropping height of the steel ball is increased but the luminance uniformity is still measured to be 1.40 or less in the ball drop testing, elasticity is inferred to be superior, whereby the three-dimensional structures of the structural layer may not be damaged by external impact.

Also, the light-condensing optical sheet has an elastic modulus of 0.05 to 100 kgf/mm² and may exhibit superior resilience under external impact.

### Mode for Invention

A better understanding of the present invention may be obtained through the following examples and comparative examples which are set forth to illustrate, but are not to be construed to limit the scope of the present invention, as will be apparent to those skilled in the art.

### Example 1

A curable resin comprising 75 wt % of a urethane acrylate oligomer, 10 wt % of phenoxyethyl methacrylate (Sartomer, SR340), and 15 wt % of phenoxyethyl acrylate (Sartomer, SR339) was prepared.

100 parts by weight of the prepared curable resin was mixed with 1.5 parts by weight of a photoinitiator, 2,4,6-trimethylbenzoyl diphenylphosphine oxide, and 2.5 parts by weight of an additive, bis(1,2,2,6,6-pentamethyl-4-piperidyl)sebacate, at 60° C. for 1 hr, yielding a composition for forming a structural layer.

Subsequently, the composition for forming a structural layer was applied on one surface of polyethylene terephthalate (made by KOLON) as a substrate layer, and the substrate layer was placed on the frame of a prism shaping roller at 35° C., after which light was radiated in an amount of 300 mJ/cm² onto the substrate layer using a UV radiation system (600 Watt/inch², made by Fusion) provided with a type-D bulb, thus forming linear triangular prisms having a vertex angle of 90°, a pitch of 50 μm, and a height of 25 μm, thereby manufacturing a light-condensing optical sheet.

### Example 2

A light-condensing optical sheet was manufactured in the same manner as in Example 1, with the exception that 1-hydroxy-cyclohexyl-phenylketone was used as the photoinitiator and the amount of light was changed as shown in Table 1 below.

### Examples 3 to 5

Light-condensing optical sheets were manufactured in the same manner as in Example 1, with the exception that the amount of light was changed as shown in Table 1 below.

### Example 6

A light-condensing optical sheet was manufactured in the same manner as in Example 1, with the exception that methylbenzoyl formate was used as the photoinitiator and the amount of the photoinitiator was changed as shown in Table 1 below.

### Examples 7 to 12

Light-condensing optical sheets were manufactured in the same manner as in Example 1, with the exception that the amount of the photoinitiator was changed as shown in Table 1 below.

### Comparative Examples 1 to 12

Light-condensing optical sheets were manufactured in the same manner as in Example 1, with the exception that the amount of light and/or the photoinitiator were changed as shown in Table 1 below.

TABLE 1

| | Amount of Light | Amount of Photoinitiator |
|---|---|---|
| | (mJ/cm²) | (parts by weight) |
| Ex. 1 | 200 | 2.0 |
| Ex. 2 | 700 | 2.0 |
| Ex. 3 | 1200 | 2.0 |
| Ex. 4 | 1700 | 2.0 |
| Ex. 5 | 2200 | 2.0 |
| Ex. 6 | 1200 | 1.0 |
| Ex. 7 | 1200 | 1.5 |
| Ex. 8 | 1200 | 2.0 |
| Ex. 9 | 1200 | 2.5 |
| Ex. 10 | 1200 | 3.0 |
| Ex. 11 | 1200 | 3.5 |
| Ex. 12 | 1200 | 4.0 |
| C. Ex. 1 | 100 | 2.0 |
| C. Ex. 2 | 100 | 4.0 |
| C. Ex. 3 | 100 | 6.0 |
| C. Ex. 4 | 2500 | 2.0 |
| C. Ex. 5 | 2500 | 4.0 |
| C. Ex. 6 | 2500 | 6.0 |
| C. Ex. 7 | 100 | 0.5 |
| C. Ex. 8 | 1200 | 0.5 |
| C. Ex. 9 | 2200 | 0.5 |
| C. Ex. 10 | 100 | 5.0 |
| C. Ex. 11 | 1200 | 5.0 |
| C. Ex. 12 | 2200 | 5.0 |

The light-condensing optical sheets of Examples 1 to 12 and Comparative Examples 1 to 12 were measured for luminance and were subjected to ball drop testing through the following methods. The results are shown in Table 2 below.

(1) Luminance and Luminance Uniformity

Two light-condensing optical sheets of the examples and comparative examples were layered perpendicular to each other and fixed to a backlight unit (LM170E01, made by Heesung Electronics) for a 17″ LCD panel, and the luminance values of 13 random positions thereof were measured using a luminance meter (BM-7, made by TOPCON, Japan) and averaged.

Here, the relative luminance values were determined with respect to the measured luminance value of Example 1, which was regarded as 100% (Ref.). The results are shown in Table 2 below.

Also, luminance uniformity was determined in a manner such that luminance was measured at a total of 135 positions by the above luminance measurement method, and a luminance uniformity value was represented by the maximum value/minimum value (Max/Min) among the measured luminance values. The closer the luminance uniformity value is to 1, the better the luminance uniformity.

(2) Ball Drop Testing

Using the ball drop tester of FIG. 1, ball drop testing was performed. The ball used for ball drop testing had a weight of 68 g of and a diameter (R) of 2 cm.

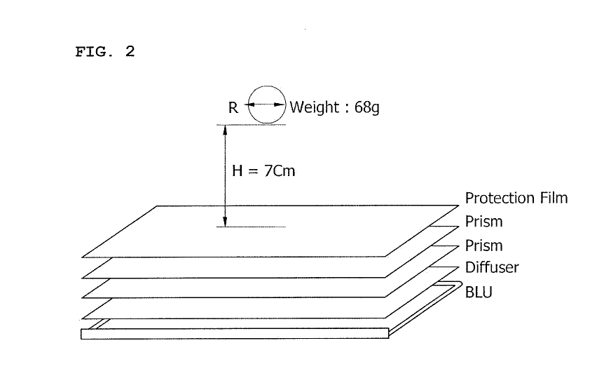

As illustrated in FIG. 2, a diffuser, two light-condensing optical sheets (prisms) and a protection film were sequentially mounted on a BLU, after which the steel ball was dropped in a perpendicular direction from heights of 2 cm, 7 cm, and 70 cm. As such, the height from which the steel ball was dropped is referred to as a ball dropping height.

When the ball dropping heights were 2 cm, 7 cm and 70 cm, the case where the luminance uniformity of the light-condensing optical sheet after dropping of the steel ball thereon was measured to be 1.40 or less was evaluated to be good, and the case where the luminance uniformity thereof was measured to exceed 1.40 was evaluated to be poor.

TABLE 2

| | | Ball Dropping | | Ball Dropping | | Ball Dropping | |
|---|---|---|---|---|---|---|---|
| | | Height (2 cm) | | Height (7 cm) | | Height (70 cm) | |
| | Luminance | Luminance | | Luminance | | Luminance | |
| | (%) | Uniformity | Result | Uniformity | Result | Uniformity | Result |
| Ex. 1 | 100 | 1.24 | Good | 1.32 | Good | 1.32 | Good |
| Ex. 2 | 101 | 1.27 | Good | 1.24 | Good | 1.24 | Good |
| Ex. 3 | 101 | 1.31 | Good | 1.26 | Good | 1.26 | Good |
| Ex. 4 | 101 | 1.34 | Good | 1.27 | Good | 1.27 | Good |
| Ex. 5 | 101 | 1.32 | Good | 1.21 | Good | 1.32 | Good |
| Ex. 6 | 100 | 1.24 | Good | 1.24 | Good | 1.21 | Good |
| Ex. 7 | 100 | 1.26 | Good | 1.37 | Good | 1.26 | Good |
| Ex. 8 | 101 | 1.27 | Good | 1.21 | Good | 1.27 | Good |
| Ex. 9 | 101 | 1.32 | Good | 1.24 | Good | 1.32 | Good |
| Ex. 10 | 101 | 1.21 | Good | 1.27 | Good | 1.21 | Good |
| Ex. 11 | 101 | 1.37 | Good | 1.31 | Good | 1.37 | Good |
| Ex. 12 | 102 | 1.31 | Good | 1.34 | Good | 1.21 | Good |
| C. Ex. 1 | 99 | 1.34 | Good | 1.49 | Poor | 1.59 | Poor |
| C. Ex. 2 | 100 | 1.32 | Good | 1.57 | Poor | 1.65 | Poor |
| C. Ex. 3 | 100 | 1.31 | Good | 1.45 | Poor | 1.54 | Poor |
| C. Ex. 4 | 99 | 1.24 | Good | 1.45 | Poor | 1.54 | Poor |
| C. Ex. 5 | 100 | 1.26 | Good | 1.47 | Poor | 1.61 | Poor |
| C. Ex. 6 | 101 | 1.27 | Good | 1.51 | Poor | 1.55 | Poor |
| C. Ex. 7 | 100 | 1.32 | Good | 1.49 | Poor | 1.51 | Poor |
| C. Ex. 8 | 101 | 1.21 | Good | 1.56 | Poor | 1.53 | Poor |
| C. Ex. 9 | 102 | 1.37 | Good | 1.52 | Poor | 1.52 | Poor |
| C. Ex. 10 | 101 | 1.21 | Good | 1.53 | Poor | 1.57 | Poor |
| C. Ex. 11 | 102 | 1.24 | Good | 1.44 | Poor | 1.56 | Poor |
| C. Ex. 12 | 103 | 1.21 | Good | 1.57 | Poor | 1.67 | Poor |

As is apparent from the results of ball drop testing of Table 2, Examples 1 to 12 were good at all of the ball dropping heights of 2 cm, 7 cm and 70 cm, but Comparative Examples 1 to 12 were poor from a ball dropping height of 7 cm.

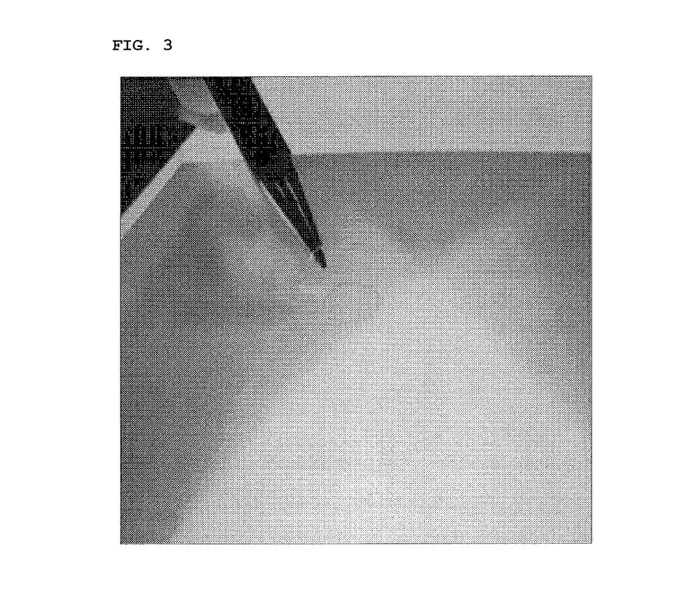

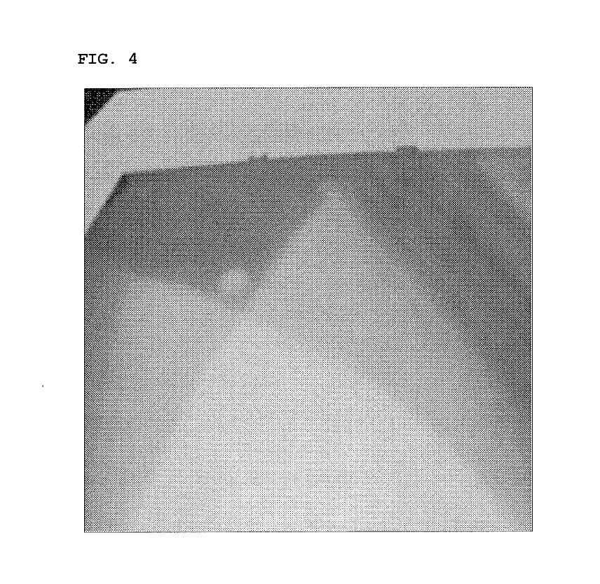

FIGS. 3 and 4 are photographs illustrating the surfaces of the light-condensing optical sheets of Examples 2 and Comparative Example 5, respectively, among Examples 1 to 12 and Comparative Examples 1 to 12.

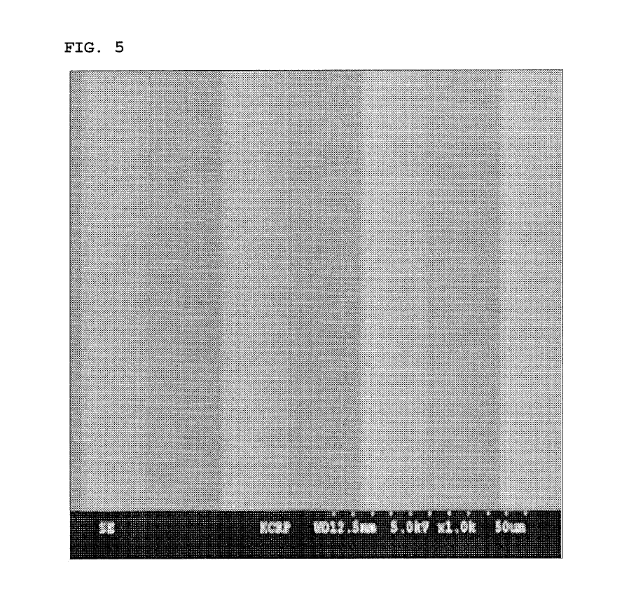

Also, FIGS. 5 and 6 are SEM images illustrating the surfaces of the light-condensing optical sheets of Examples 2 and Comparative Example 5, respectively, among Examples 1 to 12 and Comparative Examples 1 to 12.

FIGS. 3 and 4 are photographs taken using a typical digital camera to evaluate whether white or black spots were observed on the surfaces of the light-condensing optical sheets. As illustrated in FIG. 3, a defect was not formed on the light-condensing optical sheet of Example 2 under external impact, but a white spot was observed with the naked eye as seen in FIG. 4.

FIGS. 5 and 6 are SEM images of the surfaces of the light-condensing optical sheets, showing the prism structures. As shown in FIG. 5, the prism structures were not damaged in the light-condensing optical sheet of Example 2, but were damaged in Comparative Example 5, as shown in FIG. 6. In the case where the damaged prism structures are observed with the naked eye, a white spot or a black spot appears. As illustrated in FIG. 4, a white spot was observed on the light-condensing optical sheet of Comparative Example 5. Also, the light path changed and light leakage occurred in the portions where the prism structures were damaged compared to the portions where the prism structures were not damaged, thus deteriorating luminance, consequently increasing luminance uniformity.

Therefore, when the luminance uniformity of the light-condensing optical sheet is 1.40 or less after dropping of the steel ball thereon in the ball drop testing, the prism structures are not damaged, and a white spot or a black spot is not observed with the naked eye. On the other hand, when the luminance uniformity thereof exceeds 1.40, the prism structures are damaged, and thus a white spot or a black spot is observed with the naked eye.

Accordingly, as the dropping height of the steel ball at which the luminance uniformity is measured to be 1.40 or less is increased, superior results are obtained. The light-condensing optical sheet according to the present invention had a luminance uniformity of 1.40 or less even when the ball dropping height was 70 cm, and is thus deemed to be very strongly resistant to impact by an object dropping perpendicularly, compared to Comparative Examples 1 to 12.

### INDUSTRIAL APPLICABILITY

The present invention pertains to a light-condensing optical sheet for use in LCDs and a method of manufacturing the same.

1. A method of manufacturing a light-condensing optical sheet, comprising:
(S1) applying a curing composition for forming a structural layer, comprising 100 parts by weight of a curable resin and 1 to 4 parts by weight of a photoinitiator, on one surface of a substrate layer;
(S2) locating the substrate layer, coated with the composition for forming a structural layer in S1, on a frame of a shaping roller having a three-dimensional structure; and
(S3) radiating light in an amount of 200 to 2000 mJ/cm² onto the substrate layer located on the frame of the shaping roller having the three-dimensional structure so as to cure the composition, thus forming a three-dimensional structure.

2. The method of claim 1, wherein the curing composition for forming a structural layer comprises a curable resin selected from the group consisting of urethane acrylate, a trifunctional acrylate compound, a UV curable monomer, and silicon acrylate; and a photoinitiator.

3. The method of claim 1, wherein the three-dimensional structure is selected from the group consisting of a prism structure, a micro-lens structure, and a lenticular structure.

4. The method of claim 1, wherein the photoinitiator is selected from the group consisting of a phosphine oxide-, a propanone-, a ketone-, and a formate-based photoinitiator.

5. A light-condensing optical sheet including a structural layer having a plurality of three-dimensional structures, wherein a luminance uniformity of the light-condensing optical sheet is measured to be 1.40 or less after dropping of a steel ball onto the light-condensing optical sheet from a height of 7 cm or more in the following ball drop testing:
<Ball drop testing>
A light-condensing optical sheet is mounted to a backlight unit (BLU), and a steel ball having a weight of 68 g and a diameter (R) of 2 cm is dropped once onto the BLU in a perpendicular direction from a predetermined height, wherein the predetermined height indicates an interval between the ball and an upper surface of the light-condensing optical sheet in a direction perpendicular to the mounted light-condensing optical sheet.

6. The light-condensing optical sheet of claim 5, wherein the luminance uniformity of the light-condensing optical sheet is measured to be 1.40 or less after dropping of the steel ball onto the light-condensing optical sheet from a height of 70 cm or more in the ball drop testing.

7. The light-condensing optical sheet of claim 5, wherein the structural layer having the plurality of three-dimensional structures is formed from a curing composition for forming a structural layer.

8. The light-condensing optical sheet of claim 7, wherein the curing composition for forming a structural layer comprises a curable resin selected from the group consisting of urethane acrylate, a trifunctional acrylate compound, a UV curable monomer, and silicon acrylate; and a photoinitiator.

9. The light-condensing optical sheet of claim 8, wherein the photoinitiator is contained in an amount of 1 to 4 parts by weight based on 100 parts by weight of the curable resin.

10. The light-condensing optical sheet of claim 9, wherein the photoinitiator is selected from the group consisting of a phosphine oxide-, a propanone-, a ketone-, and a formate-based photoinitiator.
